(19) United States
(12) Patent Application Publication
(10) Pub. No.: US 2019/0069010 A1
(43) Pub. Date: Feb. 28, 2019

(54) Online Video and Audio Broadcasting System, Method, and Computer Program Product Thereof

(71) Applicant: VAS Creative Co., Ltd, Taipei City 115 (TW)

(72) Inventor: Tien-Ming Wang, Taipei City (TW)

(21) Appl. No.: 15/917,899

(22) Filed: Mar. 12, 2018

(30) Foreign Application Priority Data
Aug. 30, 2017 (TW) 106129604

(51) Int. Cl. H04N 21/254; H04N 21/24; G06F 21/10

(52) U.S. Cl. CPC H04N 21/2541; G06F 2221/0775; G06F 21/10; H04N 21/2404

(57) ABSTRACT

An online video and audio broadcasting system and method are disclosed. The online video and audio broadcasting system includes a first verification module, a second verification module, a management module, and a play module. The first and the second verification module is connected to a primary verification system and a backup verification system to correspond to a first set of digital rights and a second set of digital rights, respectively. The management module carries out the verification of the video and audio signal with the first set of digital rights corresponding to the first verification module. If an error occurs, the management module automatically switches to carry out the verification of the video and audio signal with the second set of digital rights corresponding to the second verification module. The play module is used for broadcasting the video and audio signal.

### BACKGROUND OF THE INVENTION

### 1. Field of the Invention

The present invention relates to an online video and audio broadcasting system and an online video and audio broadcasting method, and more particularly, to an online video and audio broadcasting system and an online video and audio broadcasting method having a verification technique with a backup capability.

### 2. Description of the Related Art

With the advancement of technologies, the types of OTT (Over-the-Top) platform providers increase continuously. OTT platform providers usually use DRM (Digital Rights Management) technologies as the verification in order to protect the viewing mechanism of authorized copyrighted content. In the prior arts, OTT platform providers may cooperate with DRM system developers and rely on the digital rights provided by the DRM system developers for carrying out the verification. However, there are potential problems with DRM systems in the prior arts. Once a problem occurs with DRM systems, the system developers may be located in different countries, and the problem may be solved only through future software revisions and version updates. In the meantime, the OTT platform provider's application program (app) must be re-approved to be released. Thus, the problem cannot be solved in a timely fashion.

Therefore, it is desirable to provide an improved online video and audio broadcasting system and an online video and audio broadcasting method to mitigate and/or obviate the aforementioned problems.

### SUMMARY OF THE INVENTION

It is a main object of the present invention to provide an online video and audio broadcasting system having a verification technique with a backup capability.

It is another main object of the present invention to provide an online video and audio broadcasting method used in the aforementioned system.

In order to achieve the above-mentioned objects, the online video and audio broadcasting system of the present invention is used between a video is and audio providing end and a video and audio display end. The video and audio providing end is capable of outputting a video and audio signal. The online video and audio broadcasting system comprises a first verification module, a second verification module, a management module, and a play module. The first verification module connects to a primary verification system to correspond to a first set of digital rights. The second verification module connects to a backup verification system to correspond to a second set of digital rights. The management module is electrically connected to the first verification module and the second verification module. Moreover, the management module is used for receiving the video and audio signal from the video and audio providing end and carrying out the verification of the video and audio signal with the first set of digital rights corresponding to the first verification module. When the management module uses the first verification module to carry out the verification, if an error occurs, the management module automatically switches to carry out the verification of the video and audio signal with the second set of digital rights corresponding to the second verification module. The play module is electrically connected to the management module and the video and audio display end. Moreover, the play module is used for broadcasting the video and audio signal to allow the video and audio signal to be displayed on the video and audio display end after the management module carries out the verification with the first set of digital rights or the second set of digital rights.

The online video and audio broadcasting method of the present invention comprises the following steps: providing a first verification module to connect to a primary verification system to correspond to a first set of digital rights; receiving a video and audio signal from a video and audio providing end; confirming if the primary verification system operates properly; if yes, carrying out the verification of the video and audio signal with the first set of digital rights corresponding to the first verification module; broadcasting the video and audio signal to allow the video and audio signal to be displayed on a video and audio display end after the first set of digital rights are verified; if no, providing a second verification module to connect to a backup verification system to correspond to a second set of digital rights; and carrying out the verification of the video and audio signal with the second set of digital rights corresponding to the second verification module.

The present invention further provides a computer program product, stored on a computer-readable medium, for carrying out the steps of the aforementioned online video and audio broadcasting method.

Other objects, advantages, and novel features of the invention will become more apparent from the following detailed description when taken in conjunction with the accompanying drawings.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1 is a schematic drawing of the structure of an online video and audio broadcasting system of the present invention.

FIG. 2 is a flowchart showing the steps of an online video and audio broadcasting method of the present invention.

### DETAILED DESCRIPTION OF THE PREFERRED EMBODIMENT

The advantages and innovative features of the invention will become more apparent from the following detailed description when taken in conjunction with the accompanying drawings.

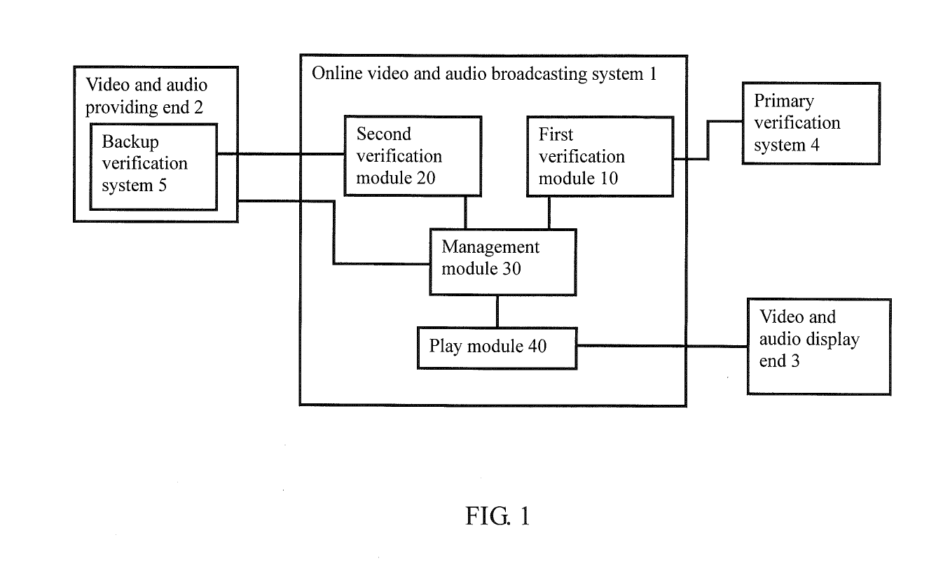

First, for the following description, please refer to FIG. 1. FIG. 1 is a schematic drawing of the structure of an online video and audio broadcasting system of the present invention.

The present invention provides an online video and audio broadcasting system 1 used between a video and audio providing end 2 and a video and audio display end 3 in a network. The video and audio providing end 2 is capable of outputting a video and audio signal. The source of the video and audio signal can be VOD (Video On Demand) or a live image generated by a live webcast interface; however, the present invention is not limited thereto. The video and audio display end 3 can be a terminal device for a user to watch, such as a television, a smartphone, a tablet computer, a notebook computer, a screen/monitor, etc. However, please note that the scope of the present invention is not limited to the above description.

The online video and audio broadcasting system 1 comprises a first verification module 10, a second verification module 20, a management module 30, and a play module 40. The first verification module 10 connects to a primary verification system 4 to correspond to a first set of digital rights. In one embodiment of the preset invention, the primary verification system 4 can be located in an external manufacturer's end (not shown in figures), which is provided by a DRM system developer. The second verification module 20 connects to a backup verification system to correspond to a second set of digital rights. In order to ensure the security of client data, the backup verification system 5 can be directly located in the intranet of the video and audio providing end 2; however, the present invention is not limited thereto. Please note that the first set of digital rights and the second set of digital rights have partially different digital rights. Moreover, in one embodiment of the present invention, the number of digital rights of the first set of digital rights is larger than the number of digital rights of the second set of digital rights. For example, the first set of digital rights can comprise Widevine, FairPlay Streaming, OMA, and PlayReady, etc. The second set of digital rights can comprise Widevine and FairPlay Streaming, etc.

The management module 30 is electrically connected to the first verification module 10, the second verification module 20, and the video and audio providing end 2. Moreover, the management module 30 is used for receiving the video and audio signal from the video and audio providing end 2 and carrying out the verification of the video and audio signal with the first set of digital rights corresponding to the first verification module 10. The play module 40 is electrically connected to the management module 30 and the video and audio display end 3. Moreover, the play module 40 is used for broadcasting the video and audio signal to allow the video and audio signal to be displayed on the video and audio display end 3 after the management module 30 carries out the verification with the first set of digital rights. Because the technique of carrying out the verification with digital rights and then broadcasting a video is well known to those of reasonable skill in the art, the detailed description of the verification process is omitted. Furthermore, when the management module 30 uses the first verification module 10 to carry out the verification, if an error occurs, the management module 30 automatically switches to carry out the verification of the video and audio signal with the second set of digital rights corresponding to the second verification module 20. This prevents the failure in broadcasting the video and audio signal caused by the error of the primary verification system 4. Thus, the play module 40 can perform the function of broadcasting the video and audio signal whether the verification is carried out with the first set of digital rights or the second set of digital rights.

It is noted that the modules of the online video and audio broadcasting system 1 may individually be configured as a hardware device, a combination of a software program and a hardware device, a combination of firmware and a hardware device, etc. For example, a computer program product can be stored on a computer-readable medium to perform the functions of the present invention. However, please note that the scope of the present invention is not limited to the above description. In addition, the embodiment described is a preferred embodiment of the present invention provided for reference. Not all possible combinations are described in detail to avoid redundancy. However, those skilled in the art may understand that not all the aforementioned modules or units are necessary. Other detailed modules or units of the prior art may be included in order to execute the present invention. Any of the modules or units can be omitted or modified depending on user requirements, and other modules or units may or may not exist between any two modules.

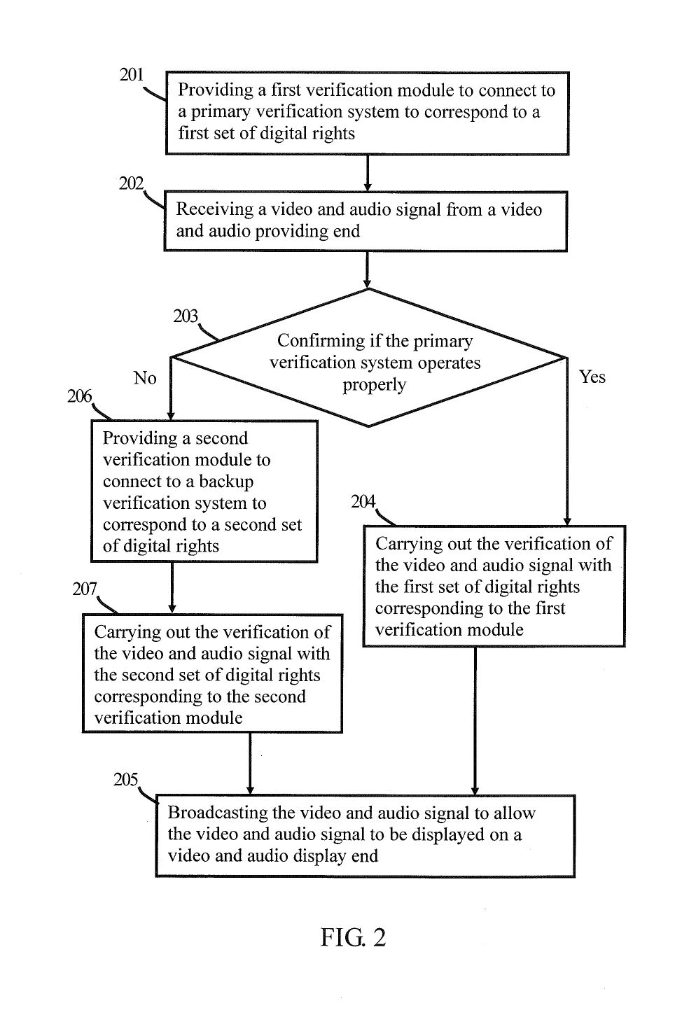

Next, please refer to FIG. 2. FIG. 2 is a flowchart showing the steps of an online video and audio broadcasting method of the present invention. Please note that the online video and audio broadcasting method of the present invention is described in the following paragraphs with the example of the aforementioned online video and audio broadcasting system 1; however, the online video and audio broadcasting method of the present invention is not limited to the use of the aforementioned online video and audio broadcasting system 1 or an equivalent structure of a system.

The present invention performs step 201 first: providing a first verification module to connect to a primary verification system to correspond to a first set of digital rights.

First, a first verification module 10 is provided. The first verification module 10 connects to a primary verification system 4 to correspond to a first set of digital rights supported by the primary verification system 4. A management module 30 can carry out the verification of the video and audio signal with the first set of digital rights corresponding to the first verification module 10.

Next, the present invention performs step 202: receiving a video and audio signal from a video and audio providing end.

In this step, the management module 30 receives the video and audio signal from a video and audio providing end 2.

Next, the present invention performs step 203: confirming if the primary verification system operates properly.

In this step, the management module 30 confirms if the first verification module 10 connects to the primary verification system 4 to carry out the verification.

If the primary verification system 4 operates properly, the present invention performs step 204 next: carrying out the verification of the video and audio signal with the first set of digital rights corresponding to the first verification module.

In this step, the management module 30 can carry out the verification of the video and audio signal with the first set of digital rights corresponding to the first verification module 10 and confirm if the video and audio signal has the digital rights.

The present invention can perform step 205 then: broadcasting the video and audio signal to allow the video and audio signal to be displayed on a video and audio display end.

A play module 40 broadcasts the video and audio signal to allow the video and audio signal to he displayed on a video and audio display end 3 after the first set of digital rights are verified.

If the primary verification system 4 operates improperly, the present invention performs step 206 next: providing a second verification module to connect to a backup verification system to correspond to a second set of digital rights.

In this step, a second verification module 20 is provided. The second verification module 20 connects to a backup verification system 5 to correspond to a second set of digital rights supported by the backup verification system 5. The management module 30 can carry out the verification of the video and audio signal with the second set of digital rights corresponding to the second verification module 20.

In this step, the management module 30 automatically switches to carry out the verification of the video and audio signal with the second set of digital rights corresponding to the second verification module 20 and confirms if the video and audio signal has the digital rights.

Last, the present invention performs step 205 similarly. The play module 40 broadcasts the video and audio signal.

It is noted that the online video and audio broadcasting method of the present invention is not limited to the order of the steps mentioned above. As long as the object of the present invention is achieved, the order of the steps mentioned above can be varied.

As we know from the above, the online video and audio broadcasting system 1 can have backup capability to prevent the failure in properly broadcasting the video and audio signal caused by the error of one verification system.

Although the present invention has been explained in relation to its preferred embodiments, it is to be understood that many other possible modifications and variations can be made without departing from the spirit and scope of the invention as hereinafter claimed.

What is claimed is:

1. An online video and audio broadcasting system, suitable for being used between a video and audio providing end and a video and audio display end, the video and audio providing end being capable of outputting a video and audio signal, the offline video and audio broadcasting system comprising:
a first verification module connecting to a primary verification system to correspond to a first set of digital rights;
a second verification module connecting to a backup verification system to correspond to a second set of digital rights;
a management module electrically connected to the first verification module and the second verification module, the management module being used for receiving the video and audio signal from the video and audio providing end and carrying out the verification of the video and audio signal with the first set of digital rights corresponding to the first verification module, wherein when the management module uses the first verification module to carry out the verification, if an error occurs, the management module automatically switches to carry out the verification of the video and audio signal with the second set of digital rights corresponding to the second verification module; and
a play module electrically connected to the management module and the video and audio display end, the play module being used for broadcasting the video and audio signal to allow the video and audio signal to be displayed on the video and audio display end after the management module carries out the verification with the first set of digital rights or the second set of digital rights.

2. The online video and audio broadcasting system as claimed in claim 1, wherein the first set of digital rights and the second set of digital rights have partially different digital rights.

3. The online video and audio broadcasting system as claimed in claim 1, wherein the number of digital rights of the first set of digital rights is larger than the number of digital rights of the second set of digital rights.

4. The online video and audio broadcasting system as claimed in claim 1, wherein the backup verification system is located in the video and audio providing end.

5. The online video and audio broadcasting system as claimed in claim 1, wherein the primary verification system is located in an external manufacturer's end.

6. An online video and audio broadcasting method, used in an online video and audio broadcasting system, comprising the following steps:
providing a first verification module to connect to a primary verification system to correspond to a first set of digital rights;
receiving a video and audio signal from a video and audio providing end;
confirming if the primary verification system operates properly;
if yes, carrying out the verification of the video and audio signal with the first set of digital rights corresponding to the first verification module;
broadcasting the video and audio signal to allow the video and audio signal to be displayed on a video and audio display end after the first set of digital rights are verified;
if no, providing a second verification module to connect to a backup verification system to correspond to a second set of digital rights; and
carrying out the verification of the video and audio signal with the second set of digital rights corresponding to the second verification module.

7. The online video and audio broadcasting method as claimed in claim 6 further comprising the following step:
locating the backup verification system in a client end.

8. The audio transmission system as claimed in claim 7, wherein the sounding device further comprises a data analysis module electrically connected to the data collection module and used for analyzing the sound information, where if the sound information exceeds a first threshold, an analysis signal is generated and used as the notice signal; and the communication module further transmits the analysis signal to the electronic device, such that the sound generation module accordingly generates a first voice signal for being returned to the sounding device, so as to allow the sounding device to output the first voice signal via the output module.

9. A computer program product, stored on a computer-readable medium, for carrying out the steps of the method of claim 6.
